(19) United States
(12) Patent Application Publication
(10) Pub. No.: US 2021/0325936 A1
(43) Pub. Date: Oct. 21, 2021

(54) BENDING HINGE FOR FLEXIBLE DISPLAY PANEL AND TERMINAL

(71) Applicant: Zhitao Zhu, Wuhan, Hubei (CN)

(72) Inventor: Zhitao Zhu, Wuhan, Hubei (CN)

(21) Appl. No.: 16/624,797

(22) PCT Filed: Oct. 30, 2019
(86) PCT No.: PCT/CN2019/114261

§ 371 Date: Dec. 19, 2019

(51) Int. Cl. G06F 1/16; G09F 9/30

(52) U.S. Cl. CPC G06F 1/1681; G06F 1/1652; G09F 9/301

(57) ABSTRACT

A bending hinge for a flexible panel and a terminal are provided. The bending hinge for a flexible panel defines a flat state and a bending state and includes a support sheet and a component chain in a zigzag shape. The component chain includes a plurality of components. A lateral section of each of the components defines a support surface. When the bending hinge is in the flat state, a spatial gap exists between the support surfaces of the lateral sections of the adjacent components. When the bending hinge is in the bending state, at least part of surfaces between the support surfaces of the lateral sections of the adjacent components contact each other under an external force.

### CROSS-REFERENCE TO RELATED APPLICATIONS

The application is the National phase under 35 U.S.C. § 371 of International Application No. PCT/CN2019/114261, filed Oct. 30, 2019, which claims the benefit of and priority to Chinese Patent Application No. 201910782561.4, filed Aug. 23, 2019. The entire contents of these patent applications are hereby incorporated by reference herein.

### FIELD OF INVENTION

The present disclosure relates to the field of display panel technology, and particularly relates to a bending hinge for a flexible display panel and a terminal.

### BACKGROUND OF INVENTION

With development of display technology, consumers' requirements for display methods, display effect, etc. are getting increasingly diversified and personalized. Compared to traditional display devices, flexible display screens, which have advantages of being bendable and stretchable, are favored by consumers widely.

With wide applications of organic light emitting diode (OLED) technology used in the display panel industry, reliability requirements of OLED products have been a bottleneck, and especially gives prominence to problems of foldability and impact resistance of flexible screens.

Therefore, it is necessary to develop a new style bending hinge to overcome the defects of the prior art.

### SUMMARY OF INVENTION

One purpose of the present disclosure is to provide a bending hinge for flexible display panel, which can solve the problem of instability of a shape of a bending region of flexible display panel, and poor impact resistance of the bending region in prior art.

In order to realize the purpose mentioned above, the present disclosure provides a bending hinge for a flexible display panel, which defines a flat state and a bending state, and includes a support sheet and a component chain in a zigzag shape. Furthermore, the component chain includes a plurality of components. A lateral section of each component defines a support surface. When the bending hinge is in the flat state, a spatial gap exists between the support surfaces of the lateral sections of the adjacent components. When the bending hinge is in the bending state, at least part of surfaces between the support surfaces of the lateral sections of the adjacent components contact each other.

Furthermore, in another embodiment, a cross section of the component is a trapezoidal shape.

Furthermore, in another embodiment, a cross section of the component is a triangular shape.

Furthermore, in another embodiment, angles of included angles between the adjacent components are same, the angle of the included angle ranges from 0 degree to 90 degrees.

Furthermore, in another embodiment, the component chain includes the plurality of components disposed with even intervals.

Furthermore, in another embodiment, the component chain includes the plurality of components disposed successively and evenly.

Furthermore, in another embodiment, a number of the components is more than two.

Furthermore, in another embodiment, specifications of the components are different.

Furthermore, in another embodiment, a material adopted by the component chain includes plastic.

Furthermore, in another embodiment, the bending hinge further includes a fastener connected to the component chain.

For realizing the purpose mentioned above, the present disclosure further provides a terminal, which includes the flexible display panel and the bending hinge related to the present disclosure.

Furthermore, in another embodiment, the terminal further includes a bendable shell, the bendable shell is used for sleeving outside of the bending hinge.

Relative to prior art, the beneficial effect of the present disclosure is to provide a bending hinge for a flexible panel and a terminal, which disposing a component chain with a structure in a zigzag shape on a support sheet. The support sheet is in a shape of a straight sheet in a natural state, and it is bendable under effect of external force. Therefore, the support sheet can support the flexible panel in the terminal, which makes the flexible panel have a flat surface no matter in a bending state or a straight state. The component chain includes a plurality of components spaced apart, a gap exists between the adjacent components. Angles of included angles between each of the components are same. When support surfaces of the adjacent components contact each other, bending of the bending hinge is at a maximum extent, and it is unable to be continued bending, thereby improving stability of a shape of flexible screen and resistance of external force and impact of the bending region of the OLED, ensuring quality of the terminal, and prolonging its service life.

### DETAILED DESCRIPTION OF PREFERRED EMBODIMENTS

To more clearly illustrate embodiments or the technical solutions of the present disclosure, the accompanying figures of the present disclosure required for illustrating embodiments or the technical solutions of the present disclosure will be described in brief. Obviously, the accompanying figures described below are only part of the embodiments of the present disclosure, from which figures those skilled in the art can derive further figures without making any inventive efforts.

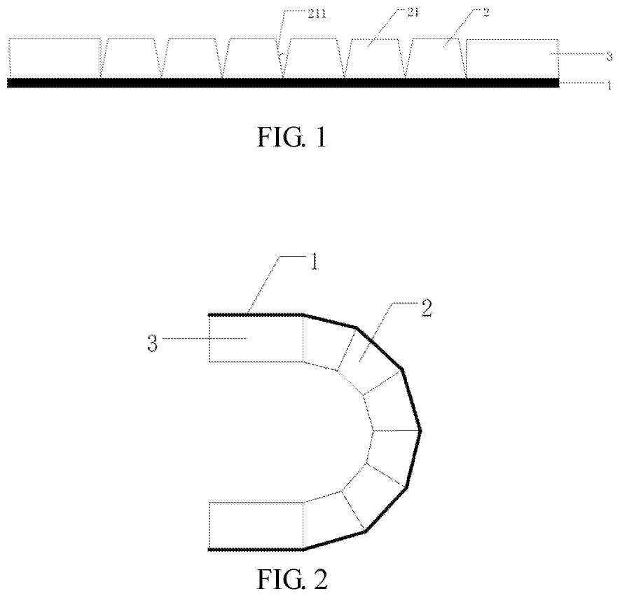

FIG. 1 is a structural schematic diagram of a bending hinge provided by a first embodiment of the present disclosure.

FIG. 2 is a structural schematic diagram of the bending hinge provided by the first embodiment of the present disclosure when it is bent at maximum extent.

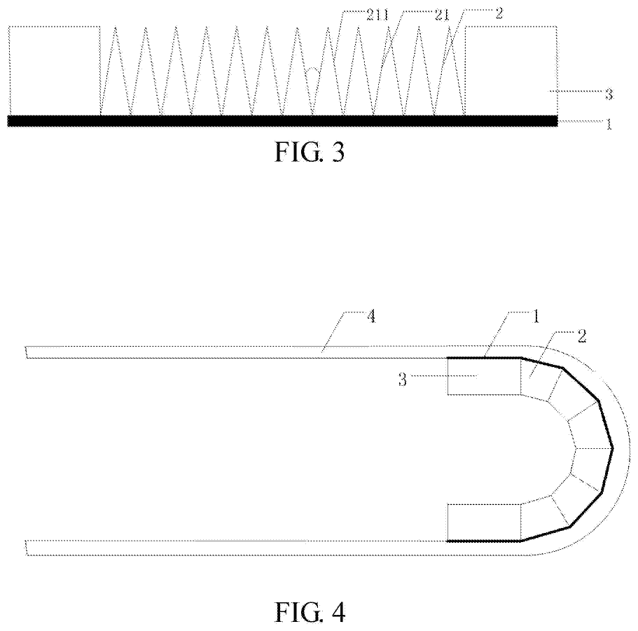

FIG. 3 a structural schematic diagram of a bending hinge provided by a second embodiment of the present disclosure.

FIG. 4 is a structural schematic diagram of a terminal provided by a third embodiment of the present disclosure in a bending state.

### DETAILED DESCRIPTION OF PREFERRED EMBODIMENTS

The technical solutions in the embodiments of the present disclosure are clearly and completely described in the following with reference to the accompanying drawings in the embodiments of the present disclosure. Obviously, the described embodiments are only part of the embodiments of the present disclosure, but are not all embodiments of the present disclosure. All other embodiments obtained by those skilled in the art based on the embodiments of the present disclosure without creative efforts are within the scope of the present disclosure.

The specific structural and functional details disclosed are merely representative and are for the purpose of describing exemplary embodiments of the present disclosure. However, the present disclosure may be specifically implemented in many alternative forms and should not be construed as being limited only to the embodiments set forth herein.

### The First Embodiment

This embodiment provides a bending hinge. Please refer to FIG. 1, FIG. 1 is a structural schematic diagram of a bending hinge provided by this first embodiment of the present disclosure, which includes a support sheet 1, a component chain 2, and a fastener 3. A component chain 2 in a zigzag shape and the fastener 3 are disposed on the support sheet, and the component chain 2 is connected to the fastener 3.

Furthermore, the component chain 2 includes a plurality of components 21. A lateral section the component 21 defines a support surface 211, and a cross section of the component 21 is a trapezoidal shape.

Furthermore, angles of included angles between the adjacent components 21 are same. In this embodiment, the angle of the included angle is 30 degrees. In another embodiment, the angle of the included angle ranges from 0 degree to 90 degrees, and is not limited herein.

In another embodiment, a number of the components 21 is more than two.

In this embodiment, specifications of each of the components 21 are same. In another embodiment, specifications of each of the components 21 can be different as long as ensures the included angles of the components 21 to be same, and is not limited herein.

In this embodiment, the component chain 2 includes the plurality of components 21 disposed successively and evenly. In another embodiment, the component chain 2 may also include the plurality of components 21 disposed with even intervals, and is not limited herein.

In this embodiment, a material adopted by the component chain 2 includes plastic.

The bending hinge has a flat state and a bending state. When the bending hinge is in the flat state, a spatial gap exists between the support surfaces 211 of the lateral sections of the adjacent components 21. When the bending hinge is in the bending state, at least part of surfaces between the support surfaces 211 of the lateral sections of the adjacent components 21 contact each other.

The support sheet 1 is in a shape of a straight sheet in the flat state, and is bendable under effect of external force. Therefore, the support sheet can support the flexible panel in a terminal, which makes the flexible panel have a flat surface no matter in the bending state or the straight state.

When the surfaces of the support surface 211 of the components 21 fully contact each other, bending of the bending hinge is at a maximum extent, at this time, the bending hinge is unable to be continued bending, thereby improving stability of a shape of flexible screen and resistance of external force and impact of the bending region of the OLED, ensuring quality of the terminal, and prolonging its service life.

### The Second Embodiment

Please refer to FIG. 3, FIG. 3 is a structural schematic diagram of a bending hinge provided by this embodiment. In this embodiment, the bending hinge structure is substantially same as that in the first embodiment, the same structure can refer to the methods mentioned above, and details will not be mentioned herein, and the main different is that a cross section of the component 21 is a triangular shape.

### The Third Embodiment

This embodiment provides a terminal. Please refer to FIG. 4, FIG. 4 is a structural schematic diagram of a terminal provided by this embodiment in a bending state. The terminal includes the bending hinge and a flexible display screen 4 relate to the first embodiment. The bending hinge is disposed on a back surface of the flexible display screen.

Furthermore, the terminal further includes a bendable shell, the bendable shell is used for sleeving outside of the bending hinge to protect the bending hinge.

The beneficial effect of the present disclosure is to provide a bending hinge for a flexible panel and a terminal, which disposing a component chain with a structure in a zigzag shape on a support sheet. The support sheet is in a shape of a straight sheet in a natural state, and is bendable under effect of external force. Therefore, the support sheet can support the flexible panel in a terminal, which makes the flexible panel have a flat surface no matter in a bending state or a straight state. The component chain includes a plurality of components spaced apart, and a gap exists between the adjacent components. Angles of included angles between each of the components are same. When support surfaces of the adjacent components contact each other, bending of the bending hinge is at a maximum extent, and it is unable to be continued bending, thereby improving stability of a shape of flexible screen and resistance of external force and impact of the bending region of the OLED, ensuring quality of the terminal, and prolonging its service life.

The above-mentioned are preferred embodiments of the present disclosure. It should be noted that those skilled in the art, without departing from the technical theory of the present disclosure, can further make many changes and modifications, and the changes and the modifications should be considered as the scope of protection of the present disclosure.

What is claimed is:

1. A bending hinge for a flexible panel defining a flat state and a bending state, comprising: a support sheet and a component chain in a zigzag shape; wherein the component chain comprises a plurality of components, a lateral section of each of the components defines a support surface; when the bending hinge is in the flat state, a spatial gap exists between the support surfaces of the lateral sections of the adjacent components; when the bending hinge is in the bending state, at least part of surfaces between the support surfaces of the lateral sections of the adjacent components contact each other.

2. The bending hinge as claimed in claim 1, wherein a cross section of the component is a trapezoidal shape.

3. The bending hinge as claimed in claim 1, wherein a cross section of the component is a triangular shape.

4. The bending hinge as claimed in claim 1, wherein angles of included angles between the adjacent components are same, the angle of the included angle ranges from 0 degree to 90 degrees.

5. The bending hinge as claimed in claim 4, wherein the component chain comprises the plurality of components disposed with even intervals.

6. The bending hinge as claimed in claim 1, wherein the component chain comprises the plurality of components disposed successively and evenly.

7. The bending hinge as claimed in claim 1, wherein a material adopted by the component chain comprises plastic.

8. The bending hinge as claimed in claim 1, wherein the bending hinge further comprises a fastener connected to the component chain.

9. A terminal, comprising a flexible display screen and the bending hinge as claimed in claim 1.

10. The terminal as claimed in claim 9, wherein the terminal further comprises a bendable shell, the bendable shell is used for sleeving outside of the bending hinge.

11. The terminal as claimed in claim 9, wherein a cross section of the component is a trapezoidal shape.

12. The terminal as claimed in claim 9, wherein a cross section of the component is a triangular shape.

13. The terminal as claimed in claim 9, wherein angles of included angles between the adjacent components are same, the angle of the included angle ranges from 0 degree to 90 degrees.

14. The terminal as claimed in claim 9, wherein the component chain comprises the plurality of components disposed with even intervals.

15. The terminal as claimed in claim 9, wherein the component chain comprises the plurality of components disposed successively and evenly.

16. The terminal as claimed in claim 9, a material adopted by the component chain comprises plastic.

17. The terminal as claimed in claim 9, wherein the bending hinge further comprises a fastener connected to the component chain.
